(19) United States
(12) Patent Application Publication
(10) Pub. No.: US 2023/0167718 A1
(43) Pub. Date: Jun. 1, 2023

(54) METHOD FOR DETERMINING SECONDARY RESERVOIR FORMATION BOUNDARIES AND COMBINED EXTRACTION OF MULTIPLE ASYMMETRIC MINING COALBED METHANE

(71) Applicants: Hancheng Zaozhuang Industrial Co., Ltd., Hancheng (CN); Chongqing University, Chongqing (CN)

(72) Inventors: Xiaoyan SUN, Hancheng (CN); Quanle ZOU, Chongqing (CN); Qican RAN, Chongqing (CN); Peimiao SANG, Hancheng (CN); Jinyan LIANG, Chongqing (CN); Wei PI, Hancheng (CN)

(73) Assignees: Hancheng Zaozhuang Industrial Co., Ltd., Hancheng (CN); Chongqing University, Chongqing (CN)

(21) Appl. No.: 17/871,561

(22) Filed: Jul. 22, 2022

(30) Foreign Application Priority Data
Nov. 26, 2021 (CN) 202111423891.8

(51) Int. Cl. E21B 43/00; E21B 43/267

(52) U.S. Cl. CPC E21B 43/006; E21B 43/267

(57) ABSTRACT

Disclosed is a method for identifying secondary reservoir formation boundaries and combined extraction of multiple asymmetric mining coalbed methane. This method fully combines the displacement transfer mechanism after multiple mining to determine its influence on a horizontal thrust of overlying strata after a first mining, and then determines evolution characteristics of pressure arches. Combining the identification of different types of pressure arches with a layout of a surface well accurately determines a secondary reservoir formation range of coalbed methane. By adopting the method of mining face overlying strata in series for combined extraction, coalbed methane from multiple mine faces is extracted by one well to greatly improve the coalbed methane extraction effect.

### CROSS-REFERENCE TO RELATED APPLICATIONS

This application claims priority to Chinese Patent Application No. 202111423891.8, filed on Nov. 26, 2021, the contents of which are hereby incorporated by reference.

### TECHNICAL FIELD

The application relates to a method for identifying secondary reservoir formation boundaries and combined extraction of multiple asymmetric mining coalbed methane.

### BACKGROUND

Under the constraint of “carbon-peaking and carbon neutrality” goals, coal and coalbed methane resources in production mines are to be fully developed and utilized, and it is of great significance for coalbed methane development to find out the distribution characteristics of pressure arches after mining in production mines. Meanwhile, as coal resources are exhausted in some mining areas, the number of closed/abandoned mines has increased year by year. Coalbed methane keeps escaping from these abandoned mines into the atmosphere, seriously threatening the safety of people's production and life around abandoned mines. At the same time, the accumulation of residual coalbed methane is also on the rise with time scale. Developing and utilizing coalbed methane resources in these abandoned mines alleviate the energy shortage problem in our country at present, and minimize the air pollution caused by the natural escape of coalbed methane in abandoned mines. It is very important to identify the secondary reservoir forming position of coalbed methane at different times for developing the remaining coalbed methane. The boundary of the remaining coalbed methane secondary reservoir area is very important for the layout parameters of surface wells.

Therefore, it is urgent to develop a method for identifying secondary reservoir formation boundaries and combined extraction of multiple asymmetric mining coalbed methane.

### SUMMARY

The objective of the application is to provide a method for identifying secondary reservoir formation boundaries and combined extraction of multiple asymmetric mining coalbed methane, so as to solve the problems existing in the prior art.

The technical scheme adopted for realizing the objective of the application is as follows: the method for determining the secondary reservoir formation boundaries and combined extraction of multiple asymmetric mining coalbed methane includes the following steps:

S1, classifying types of overlying strata failure after multiple asymmetric mining according to geological parameters and mining parameters;

S2, three-dimensional modeling for different types of overlying strata failure; identifying an initial stress distribution of overlying strata after multiple asymmetric mining as an initial stress conditions of different rock constitutive models;

S3, calculating characteristics of overlying strata block-scattered combinations in pressure arches respectively according to types of overlying strata after mining, and calculating horizontal thrust of the pressure arches on both sides respectively, so as to obtain stress boundary conditions of pressure relief positions of the pressure arches;

S4, substituting constitutive models of different layers of overlying strata considering time factors to obtain asymptotic failure characteristics of overlying strata with an increase of time scale;

S5, obtaining the pressure relief positions of mine pressure arches in different periods under different mining conditions;

S6, identifying a dominant area of high concentration coalbed methane and a rapid diversion area of fracture positions of separations respectively based on distribution characteristics of multiple mining fractures;

S7, identifying an optimal location of single working face extraction in a mine surface well; and

S8, connecting high positions within a range of multiple pressure arches with the surface well in series combined with a distribution of mine working face and the extraction capacity of a surface well, and realizing a function of long-term stable extraction by one well and multiple faces in series.

In an embodiment, in S1, the types of overlying strata failure include an alternating block-scattered combination, a cumulative increased block-scattered combination and an uncorrelated block-scattered combination. The types of overlying strata failure after multiple mining operations are based on whether there are key strata in a mined coal seam, a floor failure depth caused by a coal seam mining, and a fracture zone height or a caving zone height caused by a lower coal seam mining. If a coal seam spacing is between the floor failure depth and the caving zone height, the type of overlying strata failure is the cumulative increased block-scattered combination. If the coal seam spacing is between a sum of the floor failure depth plus the caving zone height and a sum of the floor failure depth and the fracture zone height, the type of overlying strata failure is the alternating block-scattered combination. If the coal seam spacing exceeds the floor failure depth and the fracture zone height, the type of overlying strata failure means is the uncorrelated block-scattered combination.

In an embodiment, in S2, an overlying strata fracture length under an influence of mining in different positions are comprehensively determined according to a mining thickness of coal seam and characteristics of pre-determined block-scattered combinations, combined with determination of overlying strata fracture length in masonry beam theory. Then, excavation calculation is carried out layer by layer, and an initial distribution of mining stress under multiple asymmetric mining is identified.

In an embodiment, S3 specifically includes following steps:

S3.1, calculating a caving zone distribution height and a fracture zone distribution height after a first mining, and determining an initial horizontal thrust of fractured blocks in the fracture zone;

S3.2, calculating a caving zone development height and a fracture zone development height after the first mining and a displacement space of the overlying strata of a first-mining coal seam;

S3.3, calculating a displacement space for upward transfer after secondary mining; and

S3.4, determining a secondary distribution of horizontal thrust of an upper layer of overlying strata considering an influence of vertical displacement change on horizontal thrust, identifying a horizontal thrust distribution of each rock stratum in a same manner in case of three or more mining impacts until all coal seams are mined.

In an embodiment, in S4, elements of specific overlying strata considering time factor are constructed, and the elements are serially substituted into an existing constitutive model of specific rock, so as to obtain failure characteristics of different strata of overlying strata under action of specific mining stress, determine a position of a first damaged strata in the pressure arches, and identify an outward expansion position of the pressure arches, so as to identify a change shape of the pressure arches.

In an embodiment, in S7, for the alternating block-scattered combination and the cumulative increased block-scattered combination, the surface well is arranged within pressure arches formed by them. Only pressure arches formed by upper mining is considered for the uncorrelated block-scattered combination.

In an embodiment, after S8, there are related steps of selecting a cementing material to ensure a wellbore structure stable.

In an embodiment, the cementing materials include cement, nanomaterials, dispersant and defoamer. The cement and the dispersant are mixed to obtain mixed slurry. The nanomaterial is placed in deionized water to obtain water-based nanofluid. The water-based nanofluid is put into the mixed slurry to complete a preparation of cementing materials.

In an embodiment, the cementing material includes the following components in parts by mass: 62-65 parts of CaO, 23-25 parts of SiO₂, 5-7 parts of Al₂O₃, 3-6 parts of Fe₂O₃, 10-20 parts of nanomaterial, 0.3-0.5 part of dispersant and 0.2-0.5 part of defoamer.

The technical effect of the application is undoubted: aiming at the characteristics of multiple mining of coal seams with different dip angles in China's mines, fully considering an asymmetric fracture characteristics of overlying strata caused by dip angles, and combining with the displacement transmission mechanism of overlying strata after multiple mining, the accurate identification of the existing areas of pressure arches in different layers of overlying strata is determined, and the accurate positioning of the secondary reservoir formation position of remaining coalbed methane in mines is realized. By adopting a combined extraction method where working face overlying strata are in series, coalbed methane from multiple mine faces are extracted by one well. In this way, the coalbed methane extraction effect is greatly improved. A new cementing material ensures that an L-shaped surface wellbore is not broken when exposed to a complicated mechanical environment of goafs, thus realizing long-term stable and effective drainage of L-shaped surface well passing through multiple goafs.

### BRIEF DESCRIPTION OF THE DRAWINGS

FIG. 1 is a flow chart of identifying secondary reservoir formation boundaries and combined extraction method of multiple asymmetric mining coalbed methane.

FIG. 2 is a flow chart illustrating the specific steps of determining stress boundary conditions of pressure arches after a first mining.

FIG. 3 is a schematic diagram of pressure arches.

FIG. 4 is a schematic diagram of an extraction location of a surface well in the separation fractures and fracture zones of a working face.

FIG. 5 is a schematic diagram of a layout of L-shaped surface well branches in series to jointly extract remaining coalbed methane from multiple working faces.

### DETAILED DESCRIPTION OF THE EMBODIMENTS

The present application will be further explained with reference to the following embodiments, but it should not be understood that the scope of the above subject matter of the present application is only limited to the following embodiments. Without departing from the above technical idea of the present application, all kinds of substitutions and changes could be made according to the common technical knowledge and common means in this field, which should be included in the protection scope of the present application.

### Embodiment 1

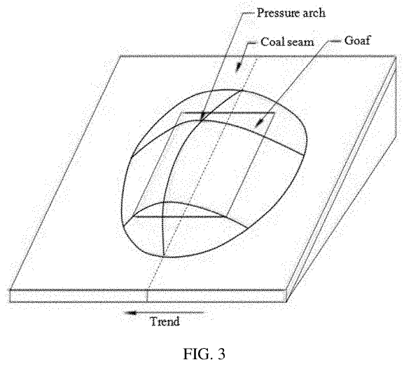

As shown in FIG. 3, with the exploitation of underground coal resources, an original three-dimensional stress balance state of the surrounding rock of the stope is broken, and the stress of the surrounding rock of the stope gradually shifts from the coal mining face to the deep part of the surrounding rock of the stope, and a stress concentration area is generated in a certain range, forming a pressure arch of the stope. A formation of surrounding rock pressure arch in stope is the result of self-regulation of surrounding rock mass in stope. The pressure arch has mechanical properties of arch structure, and exerts its own load and pressure of surrounding rock of the stope on an arch foot and surrounding stable surrounding rock.

When the coal seam is mined, an original state of the overlying strata is destroyed, and a certain range of strata above the coal seam collapses, which is called a caving zone. The above-mentioned rock strata in a certain range in the caving zone produce cracks and fractures along a bedding plane and a vertical bedding plane, and a fractured interval is called a fracture zone. The strata above the fracture zone to the surface sink and bend, showing overall movement, which is called bending subsidence zone. An abandoned coalbed methane in the mine mainly migrates to a surrounding of the overlying strata through channels such as mining fissures, and the permeability of the mining overlying strata is very sensitive to stress. Generally speaking, the permeability of the mining overlying strata is lower at a position with higher stress, so a pressure arch area is a preferred area for the secondary reservoir formation and extraction of coalbed methane.

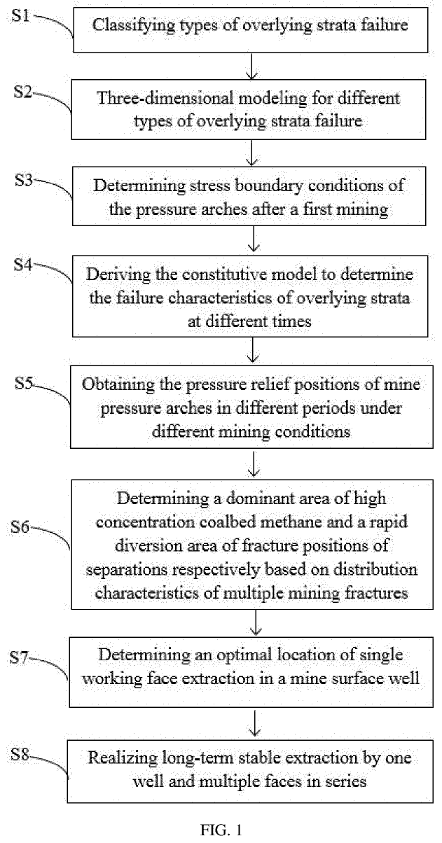

With reference to FIG. 1, this embodiment provides a method for identifying secondary reservoir formation boundaries and combined extraction of multiple asymmetric mining coalbed methane. The method for determining secondary reservoir formation boundaries and combined extraction of multiple asymmetric mining coalbed methane includes the following steps:

S1, classifying types of overlying strata failure of an abandoned mine after multiple asymmetric mining according to geological parameters and mining parameters.

S2, three-dimensional modeling for different types of overlying strata failure; determining an initial stress distribution of overlying strata after multiple asymmetric mining as an initial stress conditions of different rock constitutive models.

S3, calculating characteristics of overlying strata block-scattered combinations in pressure arches respectively according to types of overlying strata after mining, and calculating horizontal thrust of the pressure arches on both sides respectively, so as to obtain stress boundary conditions of pressure relief positions of the pressure arches.

S4, substituting constitutive models of different layers of overlying strata considering time factors to obtain asymptotic failure characteristics of overlying strata with an increase of time scale.

S5, obtaining the pressure relief positions of mine pressure arches in different periods under different mining conditions. Due to the different closing/abandonment times of different mines, the pressure arch of a single working face gradually expands outward, resulting in the horizontal expansion of the layout range of the surface well. At the same time, due to an interaction of pressure arches of overlying strata in various working faces, the pressure arches formed by multiple working faces tend to be flat, and finally, a plurality of series flat pressure arches are formed in an inclined direction of working faces. Due to the influence of coal seam dip angle, the stress distribution on both sides of mining face show obvious asymmetric characteristics. Therefore, a side of the pressure arch with small horizontal thrust corresponds to a position with small confining pressure, and the damage is more severe under a same overlying strata lithology, and the mining fissures develops more fully.

S6, determining a dominant area of high concentration coalbed methane and a rapid diversion area of fracture positions of separations respectively based on distribution characteristics of multiple mining fractures. Due to the preferential development of fractures of separations in the mining process, coalbed methane is enriched in the fracture area of separations due to uplift, and this area is also the main gas source that escapes to the ground and causes safety accidents. In the three types of block-scattered combinations formed by mining, the fractured zone has strong diversion capability, and at the same time, after long-term enrichment, the coalbed methane content in this area is high. The fractured zone is an efficient location for the extraction of the remaining coalbed methane.

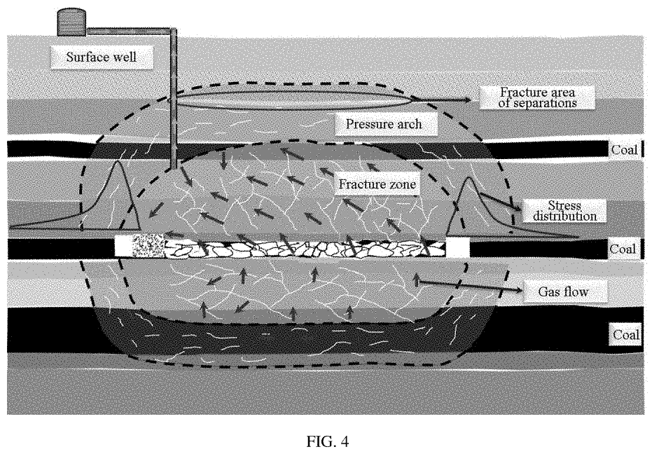

S7, identifying an optimal location of single working face extraction in a mine surface well with reference to FIG. 4.

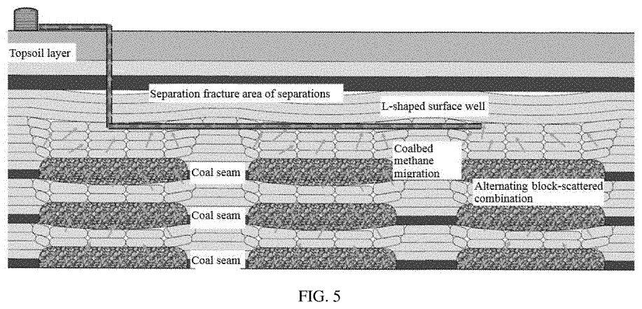

S8, extracting with an L-shaped surface well with reference to FIG. 5. High positions within a range of multiple pressure arches are connected with the surface well in series combination with a distribution of mine working face and the extraction capacity of a surface well, and long-term stable extraction is realized by one well and multiple faces in series. Absolute heights and positions of pressure arch development caused by dip angles of coal seams are different, even if the same type of block bulk combination has different extraction dominant positions. Meanwhile, because each pressure arch is relatively closed to each other, the advantageous extraction position of each pressure arch needs to be connected in series, so as to ensure that one L-shaped surface well could realize the series joint collaborative extraction of multiple blocks and loose assemblies of the same type.

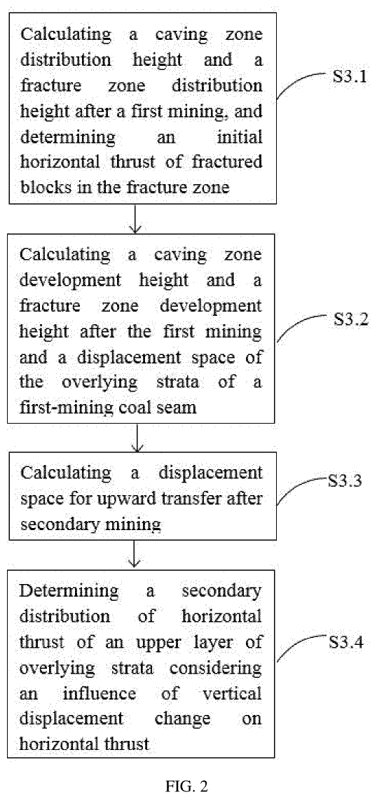

In an embodiment, as shown in FIG. 2, S3 may specifically comprise the following steps:

S3.1, calculating a caving zone distribution height and a fracture zone distribution height after a first mining, and determining an initial horizontal thrust of fractured blocks in the fracture zone.

S3.2, calculating a caving zone development height and a fracture zone development height after the first mining and a displacement space of the overlying strata of a first-mining coal seam.

S3.3, calculating a displacement space for upward transfer after secondary mining.

S3.4, determining a secondary distribution of horizontal thrust of an upper layer of overlying strata considering an influence of vertical displacement change on horizontal thrust, obtaining a horizontal thrust distribution of each rock stratum in a same manner in case of three or more mining impacts until all coal seams are mined.

Most coal seams in China exist in multiple coal groups with different dip angles, and the shape of overlying strata pressure arches change greatly after multiple mining operations. The pressure arches formed by mining play a good role in capping the secondary coalbed methane reservoir, which is conducive to the migration of coalbed methane from coal to the secondary reservoir area and forms a certain stable enrichment area. At the same time, for the surface wells that pass through many mining-affected areas, the stability of the well bore is very important for long-term stable gas extraction, and the selection of cementing materials is the key factor to ensure the stable specific well bore structure.

### Embodiment 2

The main steps of this embodiment are the same with those of Embodiment 1. In this embodiment, after the coal seam is mined, the overlying strata break and fall, and scattered structures are formed when the revolving space is large in a lower space position while broken blocks are formed due to impossibility of large-angle rotation when the revolving space is small. Therefore, after the coal seam is mined, block-scattered combinations are formed in the overlying strata.

In S1, the types of overlying strata failure after multiple mining operations include an alternating block-scattered combination, a cumulative increased block-scattered combination and an unrelated block-scattered combination. The classification basis of overlying strata failure types includes whether there are key strata in the mined coal seam, the floor failure depth caused by coal seam mining, and the fracture zone height or caving zone caused by lower coal seam mining. If a coal seam spacing is between the floor failure depth and the caving zone height, the type of overlying strata failure is the cumulative increased block-scattered combination. If the coal seam spacing is between a sum of the floor failure depth plus the caving zone height and a sum of the floor failure depth and the fracture zone height, the type of overlying strata failure is the alternating block-scattered combination. If the coal seam spacing exceeds the floor failure depth and the fracture zone height, the type of overlying strata failure means is the uncorrelated block-scattered combination.

### Embodiment 3

The main steps of this embodiment are the same as those of Embodiment 1. In this embodiment, in S2, an overlying strata fracture length under an influence of mining in different positions are comprehensively determined according to a mining thickness of coal seam and characteristics of pre-determined block-scattered combinations, combined with determination of overlying strata fracture length in masonry beam theory. Then, excavation calculation is carried out layer by layer, and an initial distribution of mining stress under multiple asymmetric mining is obtained.

### Embodiment 4

The main steps of this embodiment are the same with those of Embodiment 1. In this embodiment, in S4, elements of specific overlying strata considering time factor are constructed, and the elements are serially substituted into an existing constitutive model of specific rock, so as to obtain failure characteristics of different strata of overlying strata under action of specific mining stress, determine a position of a first damaged strata in the pressure arches, and determine an outward expansion position of the pressure arches, so as to determine a change shape of the pressure arches.

### Embodiment 5

The main steps of this embodiment are the same with those of Embodiment 1. In this embodiment, in S7, for the alternating block-scattered combination and the cumulative increased block-scattered combination, the surface well is arranged within a pressure arch formed by them. Only the pressure arch formed by upper mining is considered for the uncorrelated block-scattered combination.

### Embodiment 6

The main steps of this embodiment are the same with those of Embodiment 1. In this embodiment, after S8, there are related steps of selecting a cementing material to ensure a wellbore structure stable.

### Embodiment 7

The main steps of this embodiment are the same with those of Embodiment 6. In this embodiment, the cementing material includes cement, nanomaterials, dispersants and defoamers. The cement and the dispersants are mixed to obtain mixed slurry. The nanomaterial is placed in deionized water to obtain water-based nanofluid. The water-based nanofluid is put into the mixed slurry to complete a preparation of cementing materials.

### Embodiment 8

The main steps of this embodiment are the same with those of Embodiment 6. In this embodiment, the cementing material includes the following components in parts by mass: 62-65 parts of CaO, 23-25 parts of SiO₂, 5-7 parts of Al₂O₃, 3-6 parts of Fe₂O₃, 10-20 parts of nanomaterial, 0.3-0.5 part of dispersant and 0.2-0.5 part of defoamer.

In this embodiment, the mine overlying strata after multiple asymmetric mining is classified into the alternating block-scattered combination, the cumulative increased block-scattered combination and the uncorrelated block-scattered combination. Combined with the displacement transfer mechanism after full multiple mining, its influence on the horizontal thrust of overlying strata after the first mining is determined, and then the evolution characteristics of pressure arch are determined. Combining the identification of different types of pressure arches with the layout of the surface well accurately determines the secondary reservoir formation range of coalbed methane. By adopting the method of mining face overlying strata in series for combined extraction, the residual coalbed methane of several abandoned mine faces is extracted by one well, which greatly improves the extraction effect of coalbed methane. The cementing material ensures that the L-shaped surface well is not broken when exposed to the complicated mechanical environment of goafs, so as to realize long-term stable and effective extraction of L-shaped surface well passing through multiple goafs.

What is claimed is:

1. A method for identifying secondary reservoir formation boundaries and combined extraction of multiple asymmetric mining coalbed methane, comprising:
S1, classifying types of overlying strata failure after multiple asymmetric mining according to geological parameters and mining parameters;
S2, three-dimensional modeling for different types of overlying strata failure; determining an initial stress distribution of overlying strata after multiple asymmetric mining as an initial stress conditions of different rock constitutive models;
S3, calculating characteristics of overlying strata block-scattered combinations in pressure arches respectively according to types of overlying strata after mining, and calculating horizontal thrust of the pressure arches on both sides respectively, so as to obtain stress boundary conditions of pressure relief positions of the pressure arches;
S4, substituting constitutive models of different layers of overlying strata considering time factors to obtain asymptotic failure characteristics of overlying strata with an increase of time scale;
S5, obtaining the pressure relief positions of mine pressure arches in different periods under different mining conditions;
S6, determining a dominant area of high concentration coalbed methane and a rapid diversion area of fracture positions of separations respectively based on distribution characteristics of multiple mining fractures;
S7, determining an optimal location of single working face extraction in a mine surface well; and
S8, connecting high positions within a range of multiple pressure arches with the surface well in series combined with a distribution of mine working face and an extraction capacity of the surface well, and realizing long-term stable extraction by one well and multiple faces in series.

2. The method according to claim 1, wherein in S1, the types of overlying strata failure comprise an alternating block-scattered combination, a cumulative increased block-scattered combination and an uncorrelated block-scattered combination;
wherein the types of overlying strata failure after multiple mining operations are classified based on whether there are key strata in a mined coal seam, a floor failure depth caused by a coal seam mining, and a fracture zone height or a caving zone height caused by a lower coal seam mining; if a coal seam spacing is between the floor failure depth and the caving zone height, the type of overlying strata failure is the cumulative increased block-scattered combinations; if the coal seam spacing is between a sum of the floor failure depth plus the caving zone height and a sum of the floor failure depth and the fracture zone height, the type of overlying strata failure is the alternating block-scattered combination; if the coal seam spacing exceeds the floor failure depth and the fracture zone height, the type of overlying strata failure means is the uncorrelated block-scattered combination.

3. The method according to claim 1, wherein in S2, an overlying strata fracture length under an influence of mining in different positions are comprehensively determined according to a mining thickness of coal seam and characteristics of pre-determined block-scattered combinations, combined with determination of overlying strata fracture length in masonry beam theory; then, excavation calculation is carried out layer by layer, and an initial distribution of mining stress under multiple asymmetric mining is obtained.

4. The method according to claim 1, wherein S3 specifically comprises following steps:
S3.1, calculating a caving zone distribution height and a fracture zone distribution height after a first mining, and determining an initial horizontal thrust of fractured blocks in the fracture zone;
S3.2, calculating a caving zone development height and a fracture zone development height after the first mining and a displacement space of the overlying strata of a first-mining coal seam;
S3.3, calculating a displacement space for upward transfer after secondary mining; and
S3.4, determining a secondary distribution of horizontal thrust of an upper layer of overlying strata considering an influence of vertical displacement change on horizontal thrust, and obtaining a horizontal thrust distribution of each rock stratum in a same manner in case of three or more mining impacts until all coal seams are mined.

5. The method according to claim 1, wherein in S4, elements of specific overlying strata considering time factor are constructed, and the elements are serially substituted into an existing constitutive model of specific rock, so as to obtain failure characteristics of different strata of overlying strata under action of specific mining stress, determine a position of a first damaged strata in the pressure arches, and determine an outward expansion position of the pressure arches, so as to determine a change shape of the pressure arches.

6. The method according to claim 2, wherein in S7, for the alternating block-scattered combination and the cumulative increased block-scattered combination, the surface well is arranged within a pressure arch formed by them while only the pressure arch formed by upper mining is considered for the uncorrelated block-scattered combination.

7. The method according to claim 1, after S8, further comprising selecting a cementing material to ensure a stable wellbore structure.

8. The method according to claim 7, wherein the cementing material comprises cement, a nanomaterial, a dispersant and a defoamer; wherein the cement and the dispersant are mixed to obtain mixed slurry, the nanomaterial is placed in deionized water to obtain water-based nanofluid, and the water-based nanofluid is put into the mixed slurry to complete a preparation of cementing materials.

9. The method according to claim 8, wherein the cementing material comprises following components in parts by mass: 62-65 parts of CaO, 23-25 parts of SiO₂, 5-7 parts of Al₂O₃, 3-6 parts of Fe₂O₃, 10-20 parts of nanomaterial, 0.3-0.5 parts of dispersant and 0.2-0.5 part of defoamer.
